(19) United States
(12) Patent Application Publication
(10) Pub. No.: US 2005/0237020 A1
(43) Pub. Date: Oct. 27, 2005

(54) Method and device for operating an indicating unit on a working machine

(76) Inventor: Sven Horstmann, Berlin (DE)

Correspondence Address: PENDORF & CUTLIFF, 5111 MEMORIAL HIGHWAY, TAMPA, FL, 33634-7356, US

(21) Appl. No.: 10/525,940

(22) PCT Filed: Aug. 26, 2003
(86) PCT No.: PCT/EP03/09440

§ 371 Date: Feb. 28, 2005

(30) Foreign Application Priority Data
Aug. 28, 2002 (DE) 10240225.6

(51) Int. Cl. G05D 1/00

(52) U.S. Cl. 318/580

(57) ABSTRACT

Working machines are often used in industry for manufacturing purposes and for logicistical tasks. Said working machines perform to a certain extent predictable but often exclusively repetitive tasks. It is often difficult for people in the vicinity of the working machines to understand the regular working process of such a working machine. It is also difficult to recognise automatically performed modifications of said working process. The invention makes it possible to look ahead and point to objects within the working range of the working machine in a specific manner. As a result, persons located within the vicinity of the working machine and/or other working machines can intervene in a timely manner in the working process and can, for example, eliminate or prevent any disruptions occurring therein. The invention makes it possible to indicate the working process of the working machine per se in a specific manner in the vicinity thereof. By projecting patterns onto objects, people can very quickly understand which objects and working machines are currently involved in the working process and which steps should be subsequently carried out. Interactions between human beings and machines and between cooperating working machines are thus simplified to a significant extent.

### BACKGROUND OF THE INVENTION

1. Field of the Invention

The invention relates to a method for operation of a pointing unit on a process machine, and to a pointing unit on a process machine, as claimed in the precharacterizing clauses of patent claims 1 and 16.

2. Related Art of the Invention

Process machines are frequently used in industry for manufacturing purposes and for logistics tasks. The range in this case extends from machines with fixed programs via unmanned transport systems on tracks to autonomous systems which automatically orient themselves with respect to their surrounding area. In the past, process machines such as these have, frequently, however, carried out only repetitive tasks, which can be predicted within limits. In this case, there is no direct interaction with people who are involved in the process sequence. It is therefore often very difficult for people who are located in the immediate vicinity of the process machines only at times to become involved in the regular process sequence of a process machine. It is also difficult to identify changes carried out automatically to the process sequence and, for example, a change to the process sequence may be required owing to unexpected disturbances.

The Japanese patent application with the publication number JP 2000089163 discloses a pointing appliance by means of which it is possible to point to sought objects which are contained in video sequences. An object is in this case selected by means of a search term which is predetermined by the user. The search term can be entered in the pointing appliance by means of voice control, for example. In this case, an image which contains object hypotheses is recorded by means of an image recording unit. The object hypotheses are checked by a checking unit to determine whether they match a previously entered search term. The check can in turn be carried out by means of text identification. The direction in which the sought object is located within the video sequence is calculated by means of a further unit, based on the result of the check. Finally, a laser beam is emitted by means of a laser in the calculated direction, in order to indicate the sought object within the video sequence.

Stationary process machines which interact with people and indicate process sequences are known, and, by way of example, the Japanese patent application with the publication number JP 11085237 proposes a robot arm which extends to people and objects. The operating range of the robot arm is in this case defined in a fixed form and corresponds to a predetermined size, since this relates to a system which is installed in a fixed position. The future movement sequence of the robot arm as well as the intended position at which an object is intended to be passed to the person are projected by means of a projector for movement monitoring, based on a three-dimensional geometric data model. The projection is in this case produced 2-dimensionally on the working surface of the working area.

The US document with the patent number U.S. Pat. No. 4,714,399 proposes an automatically controlled, unmanned vehicle which is equipped with a mounting element for holding loads. The mounting element can be opened and closed selectively and is equipped with a number of sensors. The sensors are used on the one hand in order to monitor the load to be transported and surfaces located in the vicinity of the load, and on the other hand to control the movement of the mounting element automatically. However, one of these sensors at the same time also monitors the area in front of the vehicle, by which means it is possible to automatically identify obstructions which are in the way and, if necessary, to stop the vehicle.

Autonomous process machines are also known which orient themselves automatically with respect to their environment. The European patent with the patent number EP0800129 B1 describes an industrial truck which can be operated manually or automatically, by selection. The industrial truck has its own on-board monitoring system in order that it can navigate freely within the area. Depending on the predetermined transport task and the identified vehicle position within the area, the monitoring system can use the stored routes to find a suitable path, and to guide the industrial truck along this path. In order to manipulate pallets or loads, it is not necessary to arrange them previously exactly at a specific position within the area, since the monitoring system detects the position of the pallet, and appropriately adapts the movement sequence of the industrial truck. The industrial truck is also provided with a means which makes it possible to brake the vehicle when people or obstructions are present.

A driverless transport system is described in the Proceedings of the international symposium on automotive technology and automation (ISATA), Florence, May 20-24, 1991, No. Symp 24, May 20, 1991, pages 615-622, Propert P.J. et al.: “Sensor based capabilities in guided vehicles for factory automation”, which is provided with additional devices in order to allow further operation of the driverless transport system in the event of disturbances on a predetermined or selected route, for example a route which is partially or completely blocked by an obstruction. For this purpose, the driverless transport system is provided with sensors and control devices, by means of which it is possible to detect an obstruction on the predetermined or selected route and, if appropriate, to automatically reorganize or replan the route. Changes to the regular process sequence of the process machine are not communicated to people who are located in the vicinity of the process machine.

### SUMMARY OF THE INVENTION

The invention is based on the object of providing a novel method for operation of a pointing unit on a process machine, as well as a process machine having a pointing device for carrying out the method as claimed in the precharacterizing clauses of patent claims 1 and 16, which makes it possible to communicate with people and/or with other process machines.

According to the invention, the object is achieved by a method and a pointing unit having the features of patent claims 1 and 16. Advantageous refinements and developments of the invention are described in the dependent claims.

According to the invention, a process machine is operated in conjunction with sensors. In this case, the sensors are used to dynamically record the area surrounding the process machine, with object identification being carried out by means of a computer unit on the basis of the detection of the surrounding area. Obstructions detected during the object identification in the working area of the process machine are taken into account and cause the process machine to be switched off or the process sequence to be reorganized/replanned. The process machine is now provided in an inventive manner with a pointing unit which is used for setting up optical communication between the process machine and/or other process machines. For this purpose, the pointing unit comprises an illumination unit, by means of which patterns are deliberately projected onto objects which are located in the area surrounding the process machine, for optical communication.

The invention for the first time makes it possible to deliberately indicate objects in advance in the working area of the process machine. People and/or other process machines which are located in the area surrounding the process machine can thus intervene in the process sequence in good time and, by way of example, can correct or even prevent any disturbances. The invention also makes it possible to indicate the process sequence of the process machine per se, deliberately in its surrounding area. The projection of patterns onto objects allows people to tell very quickly which objects and other process machines are currently involved in the process sequence and what steps should be carried out next. This considerably simplifies not only interactions between people and the process machine, but also between cooperating process machines.

The objects may be obstructions which are located in the working area of the process machine. The advanced indication of obstructions means that it is not absolutely essential to switch off the process machine immediately. This advanced indication of obstructions also means that it is not essential to reorganize/replan the process sequence. For example, people or other process machines can still remove obstructions from the working area in good time before the process machine reacts automatically to them and, for example, reorganizes the process sequence. It is also feasible for the objects to be objects which are related to the process sequence of the process machine. Advanced indication of the next objects to be manipulated allows people or other process machines to interact with the process machine in a simple manner. For example, someone can hand a process machine precisely that object which is indicated by it, and this also applies in a corresponding manner to other process machines; another process machine, for example, produces an object exactly at the position indicated by the process machine, and this also applies in a corresponding manner to people.

In one advantageous embodiment of the invention, it is also feasible to use a laser beam for the projection of patterns. Galvanometer scanners are particularly suitable for this purpose, and allow the laser beam to be projected very quickly and with very high position accuracy. Galvanometer scanners can be controlled by means of a computer-controlled deflection unit, so that the patterns to be projected may have any desired shape.

It is also possible by the alternative use of an illumination unit which operates in conjunction with an array of optical lenses to project patterns with any desired extent onto the objects. By way of example, an illumination means having a fiber-coupled lens array may be used as the optical illumination unit. In the same way, it is also feasible to use illumination means which are known from automobile engineering for the purposes of the invention, in which the shape and intensity of the light beam of a spotlight or headlight can be varied. Such illumination is intended to be used to avoid dazzling the drivers of oncoming vehicles, and to illuminate the curves better when turning. The international patent application WO 98/54030 proposes various forms for the configuration of such illumination means, based on the example of a vehicle spotlight or headlight.

It is also feasible for the illumination unit to be an illumination unit which is already intended for other purposes in conjunction with the process machine. For example, process machines frequently use illumination sources to indicate the direction in which they are traveling. The use of the same illumination source for different purposes on the one hand saves costs and on the other hand consumes less electrical power, which is particularly advantageous in the case of process machines powered by rechargeable batteries.

The method according to the invention allows patterns with any desired shapes to be projected in a general form. However, it has been found to be particularly advantageous to project patterns which are in this case in the form of defined symbolic representations. Geometric shapes such as circles, triangles etc. are particularly suitable, by way of example, and it is also feasible to project script characters or numbers. It is thus possible to associate a unique pattern with each process machine for projection. People or other process machines can thus more easily associate the projected patterns with that particular process machine.

The unique association of the patterns with a process machine may, however, also be achieved by the use of different blinking frequencies for projection.

It is also feasible for the patterns to be projected to extend completely over that surface of the object which is visible from the viewing direction of the process machine, and thus to be identified at a glance.

In addition, it has also been proven for the patterns to be projected only onto a portion of the surface of the object which is visible from the viewing direction of the process machine. Specific information can thus be projected at positions being looked for (for example the left upper corner) on the object surface.

In a further advantageous refinement of the invention, it has been proven for the patterns to be projected in a blinking form. Particularly in the case of very bright objects or structured projection surfaces, blinking projection of the patterns can be seen more clearly than continuous projection against the background. A blinking representation of a pattern may, however, also advantageously be linked to a particular event occurring in the area surrounding the process machine. For example, when the rechargeable battery in a process machine is virtually discharged. The blinking frequency can also be varied dynamically. For example, once an obstruction has been identified in the process sequence, it is possible to initially illuminate this continuously. If the obstruction is not removed, the process machine then starts to replan the process sequence. Until the amended process sequence is actually continued, the pattern is represented using an increasing blinking frequency. A means which allows the respective light source to be operated in a pulsed form can be provided for this purpose, depending on the chosen light source.

It is also feasible to automatically vary the intensity of the illumination on the basis of changing environmental conditions. A change in the environmental conditions can indicate that the background lighting resulting from daylight is changing. However, external light sources which vary on the basis of production processes (for example in the case of welding), or changing light sources on other process machines can be compensated for well by automatically varying the intensity of the illumination. A further significant point is a change in the condition of the projection surface, so that the color or the structure of the surface to which the pointing unit is pointing may differ at different points. Such differences can be compensated for particularly well by automatic variation of the illumination intensity. In this context, a further means can be provided by means of which such changes in the environmental conditions can be detected, in particular, with cameras or photo-elements being particularly suitable for this purpose.

In a further advantageous refinement of the invention, light at different wavelengths is used for illumination. If two or more autonomous process machines are working in the same area, then each process machine may be allocated a separate wavelength, in order to distinguish better between them. In this case, the wavelengths should be chosen such that their difference is ideally more than 50 nm so that the wavelength band which is visible to a human observer can be subdivided into a large number of colors which can still be clearly distinguished.

In particular, it has been proven for the illumination to use light in the non-visible wavelength range, in particular in the infrared. This makes it possible reliably indicate the process sequences of different autonomous systems, thus minimizing the influences of the environmental lighting. For this purpose, each autonomous system is preferably allocated one fixed wavelength in the infrared band. The wavelengths for the respective machines may in this case be very close to one another, so that one wavelength can be uniquely allocated for a large number of process machines.

It has also been proven for the illumination source to be switched on and off in order to illuminate the working area, taking account of environmental conditions. Particularly when no people or any other autonomous systems are located in the area surrounding the process machine, it is worthwhile switching off the illumination means used for projection, thus saving energy.

The illumination means which have been mentioned in conjunction with the pointing unit in some cases have restricted emission angles and can thus not emit light over the entire area around a process machine. In a further advantageous refinement of the invention, an additional means is therefore provided, in order to automatically change the position and/or the orientation of the illumination unit on the process machine. For the first time, this makes it possible to cover the entire area around a process machine, even when using illumination sources with narrow beams.

The invention can also be used in a particularly advantageous manner in conjunction with mobile process machines, in particular driverless transport systems. This allows interactions between people and a process machine as well as between cooperating process machines to be considerably simplified even in complex industrial scenarios.

1. A method for operation of a process machine in conjunction with sensors, comprising:
dynamically recording the area surrounding the process machine with object identification being carried out by means of a computer unit,
switching off the process machine or reorganizing a process sequence by taking obstructions detected during the object identification in the working area of the process machine into account,
wherein optical communication is set up by means of a pointing unit, which is fitted to the process machine, between the process machine and people and/or other process machines,
wherein patterns are deliberately projected onto objects located in the area surrounding the process machine by means of an illumination unit, for optical communication.

2. The method as claimed in claim 1, wherein
the objects are obstructions in the working area of the process machine,
which should be removed by people and/or other process machines.

3. The method as claimed in claim 1, wherein
the objects are objects which are related to the process sequence of the process machine,
and which should be manipulated by people and/or other process machines.

4. The method as claimed in claim 1, wherein
a laser beam is used as the illumination unit for projection of patterns onto objects,
and the laser beam is controlled by a computer-controlled deflection unit.

5. The method as claimed in claim 1, wherein
an illumination unit which operates in conjunction with an array of adjustable optical lenses is used for projection of patterns onto objects.

6. The method as claimed in claim 1 wherein
the illumination unit is an illumination source which is already provided for other purposes in conjunction with the process machine.

7. The method as claimed in claim 1 wherein
the projected pattern corresponds to a defined symbolic representation.

8. The method as claimed in claim 1 wherein
the projected pattern extends completely over that surface of the object which can be seen from the viewing direction of the process machine.

9. The method as claimed in claim 1 wherein
the pattern extends only over a portion of that surface of the object which can be seen from the viewing direction of the process machine.

10. The method as claimed in claim 1 wherein
the pattern is projected in a blinking form.

11. The method as claimed in claim 1 wherein
the intensity of the illumination is varied automatically on the basis of changing environmental conditions.

12. The method as claimed in claim 1 wherein
light at different wavelengths is used for illumination.

13. The method as claimed in claim 1 wherein
light in the non-visible wavelength band, in particular in the infrared, is used for illumination.

14. The method as claimed in claim 1 wherein
the illumination source is switched on and off depending on the environmental conditions.

15. (canceled)

16. A process machine, comprising sensors by means of which data relating to the surrounding area is recorded dynamically during operation of the process machine,
a computer unit by means of which object identification is carried out on the basis of the data relating to the surrounding area,
a control unit and further means are provided, in order to switch off, reorganize or replan the process sequence taking into account obstructions detected in the working area of the process machine, wherein
the process machine is provided with a pointing unit for communication purposes, with the pointing unit having an illumination unit,
by means of which communication is carried out between the process machine and people and/or other process machines,
and by means of which patterns are deliberately projected onto objects which are located in the area surrounding the process machine.

17. The process machine as claimed in claim 16, wherein
a galvanometer scanner is provided as the optical illumination unit.

18. The process machine as claimed in claim 16, wherein
an illumination means which comprises a fiber-coupled lens array is provided as the optical illumination unit.

19. The process machine as claimed in claim 16, wherein
the optical illumination unit is already provided for other purposes in conjunction with the process machine.

20. The process machine as claimed in claim 16, wherein
a means is provided in order to operate the illumination means in a pulsed form.

21. The process machine as claimed in claim 16, wherein
an additional means is provided in order to automatically change the position and/or the orientation of the illumination unit on the process machine.

22. (canceled)
